(19) United States
(12) Patent Application Publication
(10) Pub. No.: US 2024/0199491 A1
(43) Pub. Date: Jun. 20, 2024

(54) SPECIAL ADDITIVE FOR FULLY RECYCLED AGGREGATE COMMERCIAL CONCRETE

(71) Applicant: Huizhou Senluoke Material Technology Co., Ltd, Huizhou (CN)

(72) Inventors: Pinrong Shao, Huizhou (CN); Zishan Shao, Huizhou (CN); He Li, Huizhou (CN); Zifu Shao, Huizhou (CN)

(21) Appl. No.: 18/347,160

(22) Filed: Jul. 5, 2023

(30) Foreign Application Priority Data
Dec. 20, 2022 (CN) 2022116426598

(51) Int. Cl. C04B 24/26; C04B 18/167

(52) U.S. Cl. CPC C04B 24/2664; C04B 18/167; C04B 2103/32

(57) ABSTRACT

The invention discloses a special additive for fully recycled aggregate commercial concrete, comprising following raw materials in parts by weight: 60 parts of polycarboxylate superplasticizer with the water-reducing rate of not less than 27%, 5 parts of water control agent, 10 parts of powder and cement regulator, 2 parts of an anti-sticking agent, 10 parts of super slump retaining agent, 8 parts of strength enhancer, and 5 parts of sustained-release agent. The special additive for the fully recycled aggregate commercial concrete, which is prepared by the invention, controls the water absorption amount and speed of the aggregate according to the characteristics of the recycled aggregate, and excites the self-curing function of the aggregate, accordingly keeping the effective slump of the commercial concrete unchanged in 2+ hours, having advantages of good workability, keeping(improving) concrete strength, enhancing concrete durability, and reducing production cost of the commercial concrete.

### 1. TECHNICAL FIELD

The invention relates to the technical field of concrete, in particular to a special additive for fully recycled aggregate commercial concrete.

### 2. BACKGROUND ART

With the rapid development of the our economy and urbanization, it is of great urgency to spare no effort to promote implementation strategies of “comprehensive conservation and cyclic utilization of resource and strengthening disposal of solid waste and garbage”.

In concrete and its related industries, on one hand, we are faced with serious shortage of natural sand and the risk of damaging the natural environment by cutting into the mountain for taking stone; on the other hand, we are confronted with mountains of solid waste; the cement concrete solid waste generated by urban renewal cannot be digested, leading to occupation of precious cultivated land resources and severe pollution of our working and living environment, directly or indirectly damaging the atmospheric environment, the soil environment and the underground water environment, and bringing no end of trouble for the future; this is a worldwide problem and also a survival and development problem which we are faced and urgently needed to be solved.

The most purposes of the concrete recycled aggregate at present are as follows: brick making and landfill. There are many recycled aggregates such as: mud, decoration waste, clay waste, etc. have been used for making bricks. Making brick by using the recycled concrete aggregate which can replace sand and stone not only extrudes the recycling space of other wastes, but also is extremely uneconomical; and its landfill is the time bomb of secondary disaster.

The industrial utilization of the construction solid waste becomes the focus of the construction solid waste disposal at the present stage. The recycled concrete aggregate has the defects of high water absorption, low crushing value, high mud and powder content and the like, therefore the recycled fine aggregate is rarely used in commercial concrete at home and abroad at present, and the use range of the recycled coarse aggregate is only 20-50%.

The concrete additive is generated to solve the problems of transportation, construction, durability and strength maintenance of commercial concrete. The special additive for fully recycled aggregate commercial concrete can fully utilize the recycled concrete aggregate (coarse and fine) with high efficiency and high additional value, simultaneously maintain (enhance) the concrete strength, improve the concrete durability and reduce the production cost of the commercial concrete.

### 3. SUMMARY OF THE INVENTION

Aimed at the defects in prior art, the invention provides a special additive for fully recycled aggregate commercial concrete, which is simple and reasonable in structure and convenient to promote.

A special additive for fully recycled aggregate commercial concrete, comprising following raw materials in parts by weight: 50-70 parts of polycarboxylate superplasticizer; 3-8 parts of water control agent, 5-15 parts of powder and cement regulator, 0.1-3 parts of anti-sticking agent, 5-20 parts of super slump retaining agent, 5-20 parts of strength enhancer, and 3-15 parts of sustained-release agent.

Preferably, the invention comprises following raw materials in parts by weight: 60 parts of polycarboxylate superplasticizer, 5 parts of water control agent, 10 parts of powder and cement regulator, 2 parts of anti-sticking agent, 10 parts of super slump retaining agent, 8 parts of strength enhancer, and 5 parts of sustained-release agent.

Preferably, the invention comprises following raw materials in parts by weight: 55 parts of polycarboxylate superplasticizer, 4 parts of water control agent, 8 parts of powder and cement regulator, 3 parts of an anti-sticking agent, 12 parts of super slump retaining agent, 7 parts of strength enhancer, and 4 parts of sustained-release agent.

Preferably, the invention comprises following raw materials in parts by weight: 65 parts of polycarboxylate superplasticizer, 6 parts of water control agent, 7 parts of powder and cement regulator, 4 parts of anti-sticking agent, 15 parts of super slump retaining agent, 8 parts of strength enhancer, and 6 parts of sustained-release agent.

Preferably, the water-reducing rate of polycarboxylate superplasticizer is not less than 27%.

The advantageous effects of the invention are as follow:

The special additive for the fully recycled aggregate commercial concrete prepared by the invention, controls the water absorption amount and speed of the aggregate according to the characteristics of the recycled aggregate, and excites the self-curing function of the aggregate, accordingly keeping the effective slump of the commercial concrete unchanged in 2+ hours, having advantages of good workability, keeping(improving) concrete strength, enhancing concrete durability, and reducing production cost of the commercial concrete.

### 4. BRIEF DESCRIPTION OF ACCOMPANY DRAWINGS

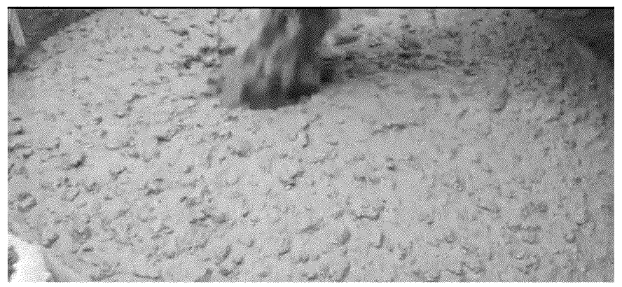

In order to illustrate the technical scheme of the preferred embodiment more clearly, the technical scheme of the preferred embodiment or the figures required is further described briefly. Obviously, only partial embodiments of the invention are shown and the actual structure is not limited thereto. It is to be understood by those skilled in the art that other drawings can be obtained based on the drawings of the invention with non-creative labor. FIG. 1 is the pump drawing of C30 fully recycled aggregate concrete at a construction site.

### 5. SPECIFIC EMBODIMENT OF THE INVENTION

In order to make the objects, technical solutions and advantages of the embodiments of the invention clearer, the technical solutions in the embodiments of the invention will be clearly and completely described below with reference to the drawings in the embodiments of the invention, and it is obvious that the described embodiments are some, but not all, embodiments of the invention. The components of embodiments of the invention generally described and illustrated in the figures herein may be arranged and designed in a wide variety of different configurations.

### Embodiment 1

A special additive for fully recycled aggregate commercial concrete, comprising following raw materials in parts by weight: 60 parts of polycarboxylate superplasticizer with the water-reducing rate of not less than 27%, 5 parts of water control agent, 10 parts of powder and cement regulator, 2 parts of anti-sticking agent, 10 parts of super slump retaining agent, 8 parts of strength enhancer, and 5 parts of sustained-release agent.

The raw materials are uniformly mixed to obtain the product.

### Embodiment 2

A special additive for fully recycled aggregate commercial concrete, comprising following raw materials in parts by weight: 55 parts of polycarboxylate superplasticizer with the water-reducing rate of not less than 27%, 4 parts of water control agent, 8 parts of powder and cement regulator, 3 parts of an anti-sticking agent, 12 parts of super slump retaining agent, 7 parts of strength enhancer, and 4 parts of sustained-release agent.

The raw materials are uniformly mixed to obtain the product.

### Embodiment 3

A special additive for fully recycled aggregate commercial concrete, comprising following raw materials in parts by weight: 65 parts of polycarboxylate superplasticizer with the water-reducing rate of not less than 27%, 6 parts of water control agent, 7 parts of powder and cement regulator, 4 parts of an anti-sticking agent, 15 parts of super slump retaining agent, 8 parts of strength enhancer, and 6 parts of sustained-release agent.

The raw materials are uniformly mixed to obtain the product.

The fully recycled aggregate concrete trial preparation of the special additive C30-C50 for the recycled aggregate commercial (Pre-mixed) concrete.

TABLE 1
C30 trial table:
Mix Ratio: C30

| | | | | | | | Recycled | Recycled | |
|---|---|---|---|---|---|---|---|---|---|
| | | | | | | Recycled | coarse | coarse | |
| | | | | | Slag | fine | aggregate | aggregate | |
| | Material | Water | Cement | Flyash | powder | aggregate | (small) | (large) | Additive |
| Mix | Dosage | 180 | 215 | 80 | 42 | 970 | 335 | 511 | 19 |
| ratio | kg/m³ | | | | | | | | |

| | | | | | | | | | | | Freeze | Freeze | |
|---|---|---|---|---|---|---|---|---|---|---|---|---|---|
| | Mixture fluidity(mm) | | | | Apparent | Compressive strength(Mpa) | | | | | thawing | thawing | Water |
| | | | Slump | Flow | density | | | | | Freeze | quality | strength | absorption |
| | Slump | Flow | after 3 h | after 3 h | (kg/m³) | 7 d | 28 d | 90 d | 180 d | thawing | loss | loss | (%) |
| Result | 230 | 620 | 250 | 480 | 2215 | 22.9 | 39.8 | 41.8 | 45.3 | 42.9 | 0.1% | 5% | 1.55 |

TABLE 2
C40 trial table:
Mix Ratio: C40

| | | | | | | | Recycled | Recycled | |
|---|---|---|---|---|---|---|---|---|---|
| | | | | | | Recycled | coarse | coarse | |
| | | | | | Slag | fine | aggregate | aggregate | |
| | Material | Water | Cement | Flyash | powder | aggregate | (small) | (large) | Additive |
| Mix | Dosage | 178 | 270 | 80 | 60 | 952 | 300 | 531 | 24 |
| ratio | kg/m³ | | | | | | | | |

| | | | | | | | | | | | Freeze | Freeze | |
|---|---|---|---|---|---|---|---|---|---|---|---|---|---|
| | Mixture fluidity(mm) | | | | Apparent | Compressive strength(Mpa) | | | | | thawing | thawing | Water |
| | | | Slump | Flow | density | | | | | Freeze | quality | strength | absorption |
| | Slump | Flow | after 2 h | after 2 h | (kg/m³) | 7 d | 28 d | 90 d | 180 d | thawing | loss | loss | (%) |
| Result | 230 | 550 | 260 | 570 | 2225 | 33.0 | 44.1 | 49.9 | 55.2 | 53.2 | 0.1% | 4% | 0.87 |

TABLE 3
C50 trial table
Mix Ratio: C50

| | | | | | | | Recycled | Recycled | |
|---|---|---|---|---|---|---|---|---|---|
| | | | | | | Recycled | coarse | coarse | |
| | | | | | Slag | fine | aggregate | aggregate | |
| | Material | Water | Cement | Flyash | powder | aggregate | (small) | (large) | Additive |
| Mix | Dosage | 184 | 330 | 90 | 100 | 850 | 250 | 573 | 26 |
| ratio | kg/m³ | | | | | | | | |

| | | | | | | | | | | | Freeze | Freeze | |
|---|---|---|---|---|---|---|---|---|---|---|---|---|---|
| | Mixture fluidity(mm) | | | | Apparent | Compressive strength(Mpa) | | | | | thawing | thawing | Water |
| | | | Slump | Flow | density | | | | | Freeze | quality | strength | absorption |
| | Slump | Flow | after 2 h | after 2 h | (kg/m³) | 7 d | 28 d | 90 d | 180 d | thawing | loss | loss | (%) |
| Result | 260 | 580 | 260 | 570 | 2245 | 34.7 | 51.5 | 52.7 | 59.7 | 58.3 | 0.0% | 2% | 0.90 |

From the trial result in the table, the workability and durability of the fully recycled aggregate commercial concrete meet the quality standard of common concrete, the 28-day strength of the concrete meets the quality requirement of the common concrete and the 180-day strength thereof is increasing, and the result of the freeze thawing test is ideal.

The special additive for the fully recycled aggregate commercial concrete is subjected to performance detection, and main equipment and instruments adopted are precision pH meter JC021-1J, analytical balance JC566J, electronic scale JC048J, concrete mixer JC687J, flame photometer JC396 and air entrainment meter JC401J, and the detection is carried out according to GB8076-2008. The results are as follows:

TABLE 4
Concrete additive test report

| | | Standard requirement(superplasticizer) | | | | |
|---|---|---|---|---|---|---|
| | | Early- | | | | Evaluation |
| | | strength | Standard | Retarding | | (retarding |
| No. | Test item | type | type | type | Test result | type) |
| 1 | Solid content (%) | When S ≤ 25, 0.90S~1.10S (S~20) | | | 20.27 | Qualified |
| 2 | Density(g/cm³) | When D ≤ 1.1, D ± 0.02 | | | Undetected | — |
| 3 | pH value | Should be within control range | | | 4.3 | Qualified |
| | | of the manufacturer (4-9) | | | | |
| 4 | Sodium sulfate content(%) | No more than control value | | | Undetected | — |
| | | of the manufacturer | | | | |
| 5 | Cement paste fluidity, | — | | | Undetected | — |
| | 87 g water (mm) | | | | | |
| 6 | Total alkali content(%) | No more than control value | | | 0.30 | Qualified |
| | | of the manufacturer(≤3.0) | | | | |
| 7 | Chlorine ion content(%) | No more than control value | | | 0.078 | Qualified |
| | | of the manufacturer(≤0.20) | | | | |
| 8 | Water-reducing rate(%) | ≥25 | ≥25 | ≥25 | 28 | Qualified |
| 9 | Air content(%) | ≤6.0 | ≤6.0 | ≤6.0 | 3.2 | Qualified |
| 10 | Setting time | −90~+90 | −90~+120 | >+90 | Undetected | — |
| | difference(min) | | | — | — | — |

| | |
|---|---|
| Conclusion | Test results of tested samples meet technical requirements |
| | for retarding-type superplasticizer regulated by GB8076-2008. |

As can be seen from the above table, the special additive detection result for the fully recycled aggregate commercial concrete meets the technical requirements of the retarding-type superplasticizer.

For verifying the mix ratio of concrete with strength grade of C30, the main detection equipment, namely platform scale JC349J, compression-testing machine JC311J and concrete anti permeability instrument JC461-1J, are adopted, and the detection is carried out according to GB/T 50080-2016, GB/T 50081-2019, GB/T 50082-2009 and JGJ55-2011.

TABLE 5
Concrete mix ratio verification report

| | |
|---|---|
| Raw | 1. Cement:Production place brand:HONGSHI; Grade:P · 042.5; 28 d Compressive strength |
| | 50.4 Mpa. |
| material | 2. Stone:Specification:5 mm-25 mm recycled coarse aggregate; fine powder content 1.2%; |
| | clay lump content 0.2%; water absorption 4.6%, bulk density 1320 kg/m³. |
| | 3. Sand:Variety:fully recycled fine aggregate of grading zone-II; fine powder content |
| | 9.7%; clay lump content 1.0%; fineness modulus 2.5; bulk density 1320 kg/m³. |
| | 4. Flyash:Production place:Hua Tian Meng; variety:flyash of class F and grade II |
| | 5. Slag powder:Production place:Tangshan Ganglu New Material Technology Co., Ltd., |
| | variety:S95 slag powder |
| | 6. Additive 1:Production place:Sen Luo Ke, variety:retarding- type superplasticizer |

| | | | | Recycled | Recycled | Slag | | |
|---|---|---|---|---|---|---|---|---|
| | Material | Water | Cement | sand | stone | powder | Flyash | Additive1 |
| Designed | Dosage | 182 | 190 | 1000 | 840 | 80 | 50 | 31.66 |
| Mix ratio | kg/m³ | | | | | | | |
| | Proportion | 0.96 | 1.00 | 5.26 | 4.42 | 0.421 | 0.263 | 0.167 |

| | Mixture performance | | | | | Compressive | | |
|---|---|---|---|---|---|---|---|---|
| | | | Slump loss | Flow loss | | strength(Mpa) | | |
| | | | through time | through time | Density | 7 d | 28 d | Anti |
| | Slump | Flow | after 1 h | after 1 h | (kg/m³) | (Mpa) | (Mpa) | permeability |
| Verification | 235 | 575 | 25 | 75 | 2210 | 27.4 | 36.5 | 1.0 Mpa |
| Result | | | | | | | | No water |
| | | | | | | | | permeated |

The compressive strength of the concrete 7 d reaches 91% of the standard value of the
compressive strength grade, and the compressive strength of the concrete 28 d reaches
122% of the standard value thereof, the anti permeability of which meets requirement
of P8 grade of the mix ratio design.

As can be seen from the table above, the compressive strength of the concrete 7d reaches 91% of the standard value of the compressive strength grade, and the compressive strength of the concrete 28d reaches 122% of the standard value thereof, the anti permeability of which meets requirement of P8 grade of the mix ratio design.

Commercial concrete accounts for over 90% of the concrete market, and most of the concrete is transported from concrete product plants (mixing plants) to the site of use. Therefore, slump retention (workability) of concrete from factory to construction site is very important (and is an important part of ensuring concrete strength). Due to the characteristics of low crushing value and high water absorption of the recycled aggregate, the recycled aggregate commercial concrete is basically free from slump when added with the common additive, which has extremely poor workability and is dried quickly.

The special additive for the fully recycled aggregate commercial concrete, which is prepared by the invention, controls the water absorption amount and speed of the aggregate according to the characteristics of the recycled aggregate, and excites the self-curing function of the aggregate, accordingly keeping the effective slump of the commercial concrete unchanged in 2+ hours, having advantages of good workability, keeping(improving) concrete strength, enhancing concrete durability, and reducing production cost of the commercial concrete.

The invention brings following economic and social benefits for society and industry:

1. The natural sand and stone resources are exhausted seriously, and the shortage of the sand and stone resources can be greatly relieved by utilizing the recycled concrete aggregate;

2. Greatly reducing phenomenon of cutting into the mountain for taking the stone and protecting green hills and blue waters;

3. Sea sand is prevented from entering concrete market (chloride ions contained in the sea sand are the main reason for corrosion of reinforcing bars in concrete);

4. Reducing “secondary disasters” caused by landfill;

5. Building waste generated by urban renewal is greatly reduced;

6. The production cost of the concrete is greatly reduced;

7. The quality of the concrete is improved and guaranteed.

The above description is only for the purpose of illustrating the preferred embodiments of the invention and is not to be construed as limiting the invention, and any modifications, equivalents and improvements made within the spirit and principle of the invention should be included in the scope of the invention.

1. A special additive for fully recycled aggregate commercial concrete, comprising following raw materials in parts by weight: 50-70 parts of polycarboxylate superplasticizer; 3-8 parts of water control agent, 5-15 parts of powder and cement regulator, 0.1-3 parts of anti-sticking agent, 5-20 parts of super slump retaining agent, 5-20 parts of strength enhancer, and 3-15 parts of sustained-release agent.

2. The special additive for fully recycled aggregate commercial concrete of claim 1, comprising following raw materials in parts by weight: 60 parts of polycarboxylate superplasticizer, 5 parts of water control agent, 10 parts of powder and cement regulator, 2 parts of anti-sticking agent, 10 parts of super slump retaining agent, 8 parts of strength enhancer, and 5 parts of sustained-release agent.

3. The special additive for fully recycled aggregate commercial concrete of claim 1, comprising following raw materials in parts by weight: 55 parts of polycarboxylate superplasticizer, 4 parts of water control agent, 8 parts of powder and cement regulator, 3 parts of an anti-sticking agent, 12 parts of super slump retaining agent, 7 parts of strength enhancer, and 4 parts of sustained-release agent.

4. The special additive for fully recycled aggregate commercial concrete of claim 1, comprising following raw materials in parts by weight: 65 parts of polycarboxylate superplasticizer, 6 parts of water control agent, 7 parts of powder and cement regulator, 4 parts of anti-sticking agent, 15 parts of super slump retaining agent, 8 parts of strength enhancer, and 6 parts of sustained-release agent.

5. The special additive for fully recycled aggregate commercial concrete of claim 1, wherein the water-reducing rate of polycarboxylate superplasticizer is not less than 27%.
